(19) United States
(12) Patent Application Publication
(10) Pub. No.: US 2014/0318961 A1
(43) Pub. Date: Oct. 30, 2014

(54) Gas Detector

(71) Applicants: William Huang, Bade City (TW); Jung-Shun Fu, Bade City (TW); Chen-yuan Su, Bade City (TW)

(72) Inventors: William Huang, Bade City (TW); Jung-Shun Fu, Bade City (TW); Chen-yuan Su, Bade City (TW)

(21) Appl. No.: 13/873,285

(22) Filed: Apr. 30, 2013

(51) Int. Cl. G01N 27/407

(52) U.S. Cl. CPC G01N 27/407
USPC 204/424

(57) ABSTRACT

A gas detector gas that fuse both the function of an oxygen sensor and the function of a lean air fuel ratio sensor, includes a cover layer, a gas diffusion resistance layer, a buffer, a partitioning layer, a solid electrolyte layer, an air passage layer, and a heating layer stacked in sequence. First and second electrodes are respectively provided on opposite first and second surfaces of the solid electrolyte layer. The partitioning layer includes a slot facing the gas diffusion resistance layer and the first electrode. The air passage layer includes an air passage accessible to the second electrode. The buffer is received in the slot of the partitioning layer. The gas diffusion resistance layer includes outer edges exposed to exhaust gas to be tested. The exhaust gas to be tested enters the gas detector via the outer edges of the gas diffusion resistance layer and reaches a surface of the first electrode of the solid electrolyte layer via the buffer. The buffer has a porosity greater than a porosity of the gas diffusion resistance layer.

### BACKGROUND OF THE INVENTION

This invention relates to a gas detector, particularly, a gas detector serving as both a lean air-fuel ratio sensor and an oxygen sensor for detecting exhaust gas of a fuel injected engine.

Theoretically, an optimized fuel injected engine requires a complete combustion of 1 kg of gasoline with 14.7 kg of air, namely, the combusted air fuel ratio 14.7:1. However, under normal environment the actual air fuel ratio may vary depending on workings of vehicle. A normalized air fuel ratio value λ is used in the industry.

The value of λ is equivalent to actual air fuel ratio divided by the theoretical air fuel ratio (14.7). The actual air-fuel ratio is 14.7 as λ=1. The air fuel ratio is lean if λ>1. The air fuel ratio is rich if λ<1.

Conventionally, λ is controlled to be within a range of 1±0.005 in the fuel injected engines. An oxygen sensor is used to detect a change of voltage in this range for the on vehicle Engine Control Module (ECM) to adjust the fuel content needed for combustion. While a conventional oxygen sensor is passable in detecting if the fuel content is lean or rich, however, this detection neglect how rich and how lean a vehicle's fuel content becomes. One can imagine an analogy to a switch of a light bulb. An oxygen sensor turns on and off the light but does not know how much to dim the light. On the other hand, an air fuel ratio sensor which output limit currents can determine how much to dim the light following our analogy. This invention relates to the working of a gas detector that detects whether a vehicle's engine is running rich or lean (serving as the function of an oxygen sensor), and make adjustments to the lean side of fuel contents (serving as the function of a lean air fuel ratio sensor), simultaneously. So that determinant of the air fuel ratio is faster and more precise.

In order to achieve a gas detector that fuses both the function of an oxygen sensor and the function of a lean air fuel ratio sensor, the physical and material structure of both functions will need to maintain cohesive. Both the oxygen sensors and the lean air-fuel ratio sensors use zirconium oxide as the conductor for oxygen ions. Oxygen turns into oxygen ions at a side of the zirconium oxide and turns back into oxygen at the other side of zirconium oxide after the oxygen ions flow through the zirconium oxide. The oxygen sensor utilizes a partial pressure difference between an internal air passage side and an exhaust gas side. An electromotive is generated while the oxygen ions flow outwards, and the oxygen content in the exhaust gas can be determined by the magnitude of the voltage. The lean air-fuel sensor for lean fuel apply an inverse voltage to pass the oxygen from the exhaust gas side to the internal air passage side and use a porous diffusive layer to restrict the amount of oxygen to generate a limit current which can be used to determine how lean air-fuel ratio is.

In order to rapidly respond to the oxygen content in the exhaust gas, the porous protective layer of conventional oxygen sensors generally includes an opening having a large area and a small thickness to allow easy entrance of the exhaust gas. FIG. 9 shows atmosphere voltage characteristics of a conventional oxygen sensor, wherein the oxygen sensor has a rapid response from lean fuel to rich fuel in a range of 0.2-0.6 V. The current-voltage characteristics of the conventional oxygen sensor are shown in FIG. 10, wherein no horizontal limit current is generated. An air-fuel ratio sensor for lean fuel reduces the area of the opening in the porous diffusive layer and increases the length of the passage to restrict entrance of the exhaust gas. FIG. 11 shows atmosphere voltage characteristics of an air-fuel sensor currently available on the market, wherein the air-fuel ratio sensor has a slow response in a range of 0.2-0.6 V, and the air-fuel ratio sensor even can not reach 0.6 V in some cases. The current-voltage characteristics of the air-fuel ratio sensor are shown in FIG. 12, wherein horizontal limit current is generated.

Conventionally, oxygen sensor and lean air-fuel ratio sensors cannot be used to substitute one another due to their differences in functions. To fuse both sensors as one gas detector resulting the vehicle's computer (ECM) not only detecting if the fuel contents is running rich or lean, but also detecting how lean the fuel contents is, allowing further precision of adjustments that conserve more fuel and more environmentally friendly. Furthermore, conventional oxygen sensors and air-fuel ratio sensors for lean fuel are identical in their physical forms, causing troubles for car mechanics to misplace the two sensors for one another, resulting in malfunction of vehicle.

U.S. Pat. No. 5,419,828 discloses a structure for conventional air-fuel ratio sensor. A gas diffusion resistance layer covers a surface and side surfaces of sensing electrode. Exhaust gas flowing through the diffusion resistance layer reaches the sensing electrode with a time lag. It is difficult to act as an oxygen sensor for its low response.

U.S. Pat. No. 6,340,419 introduces a hollow space between diffusion resistance layer and sensing electrode. The hollow space is wider than the electrode. It is easier to collapse in hot pressing of layer stacking. The structure is also weak for a hollow space inside. Residual gas stored in the hollow space delays the response of real-time gas content.

Thus, a need exists for a novel gas detector that can serve as both of an oxygen sensor and a lean air-fuel ratio sensor.

### BRIEF SUMMARY OF THE INVENTION

The primary objective of the present invention is to provide a gas detector including both of voltage characteristics of an oxygen sensor and limit current characteristics of an air-fuel ratio sensor for use in both of conventional injection engines and novel lean fuel engines, as well as future precision engines in detecting fuel contents. The present invention can also solve the above described problems of the prior arts.

A buffer is introduced in this invention. The buffer is made of porous ceramic. The buffer has a porosity greater than a porosity of the gas diffusion resistance layer. Exhaust gas is easier to reach the surface of sensing electrode. With the fill and support of the buffer it is easy to stack the layers into to a compact integral. After sintering the structure is strong. With porous structure, residual gas in the buffer is less than in a hollow space, resulting in fast and accurate response in detection.

The above objective is fulfilled by a gas detector that include a cover layer, a gas diffusion resistance layer, a buffer, a partitioning layer, a solid electrolyte layer, an air passage layer, and a heating layer stacked in sequence. The solid electrolyte layer includes a first surface and a second surface opposite to the first surface. A first electrode is provided on the first surface, and a second electrode is provided on the second surface. The partitioning layer includes a slot facing the gas diffusion resistance layer and the first electrode of the solid electrolyte layer. The air passage layer includes an air passage accessible to the second electrode of the solid electrolyte layer. Each of the gas diffusion resistance layer and the buffer is made of porous ceramic. The buffer is received in the slot of the partitioning layer. The gas diffusion resistance layer includes outer edges adapted to be exposed to exhaust gas to be tested. The exhaust gas to be tested is adapted to enter the gas detector via the outer edges of the gas diffusion resistance layer and easily reach a surface of the first electrode of the solid electrolyte layer via the buffer.

In the form shown, the cover layer and the partitioning layer are partially pressed together, with each of the cover layer and the partitioning layer including a recessed step portion. The gas diffusion resistance layer is sandwiched and positioned by the recessed step portions of the cover layer and the partitioning layer. Two ends of the buffer respectively contact the gas diffusion resistance layer and the first electrode of the solid electrolyte layer.

The present invention will become clearer in light of the following detailed description of illustrative embodiments of this invention described in connection with the drawings.

### DESCRIPTION OF THE DRAWINGS

FIG. 1 shows a perspective view of a gas detector according to the present invention.

FIG. 2 shows another perspective view of the gas detector of FIG. 1.

FIG. 3 shows an exploded, perspective view of the gas detector of FIG. 1.

FIG. 4 shows a cross sectional view of the gas detector of FIG. 1.

FIG. 5 is a cross sectional view taken along section line A-A of FIG. 4.

FIG. 6 is a view similar to FIG. 5, illustrating use of the gas detector.

FIG. 7 is a diagram showing atmosphere voltage characteristics of the gas detector according to the present invention.

FIG. 8 is a current-voltage diagram of the gas detector.

FIG. 9 shows atmosphere voltage characteristics of a conventional oxygen sensor.

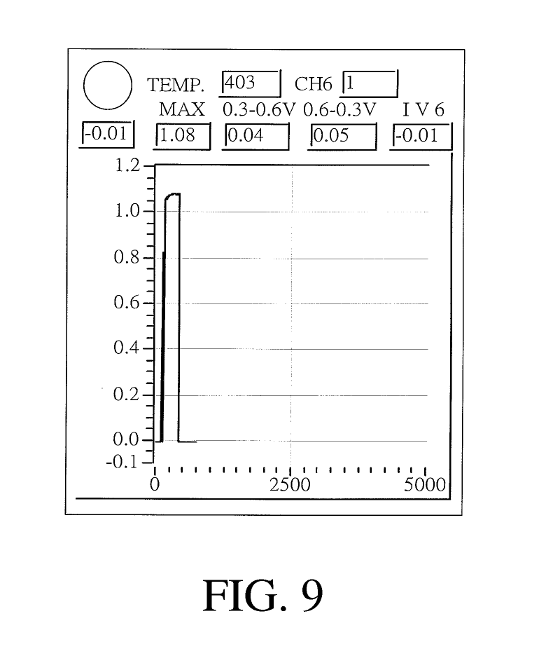

FIG. 10 is a current-voltage diagram of the conventional oxygen sensor in FIG. 9.

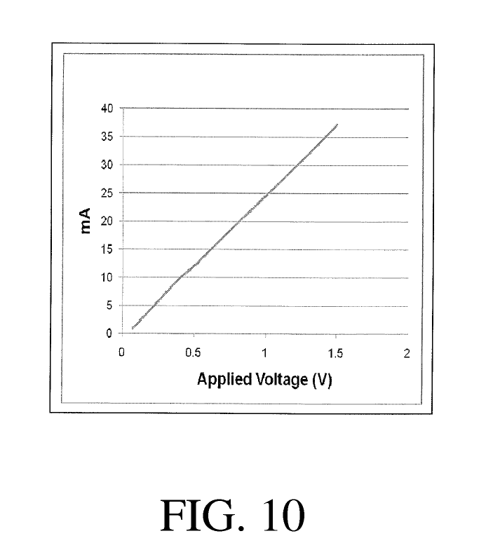

FIG. 11 shows atmosphere voltage characteristics of a conventional oxygen sensor.

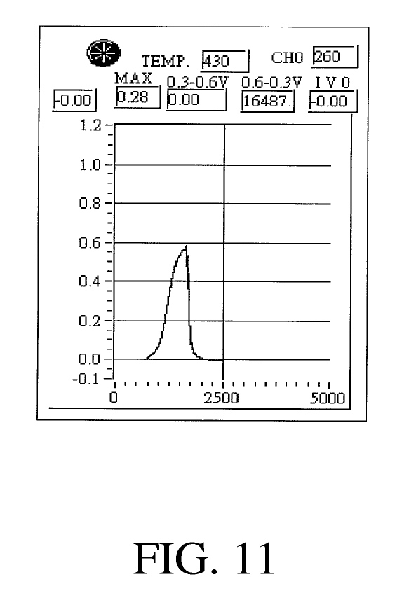

FIG. 12 is a current-voltage diagram of the air-fuel ratio sensor in FIG. 11.

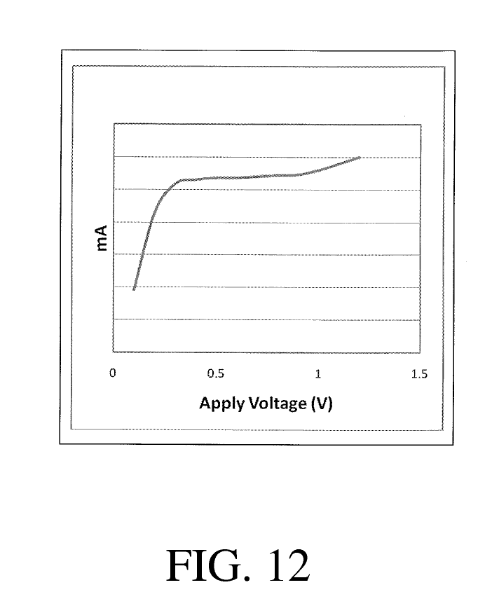

### DETAILED DESCRIPTION OF THE INVENTION

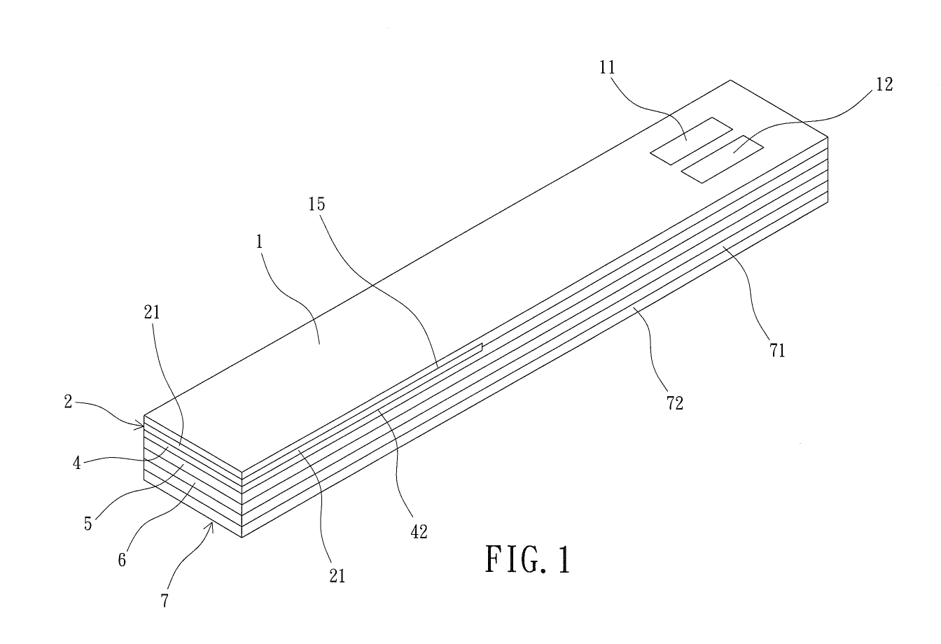

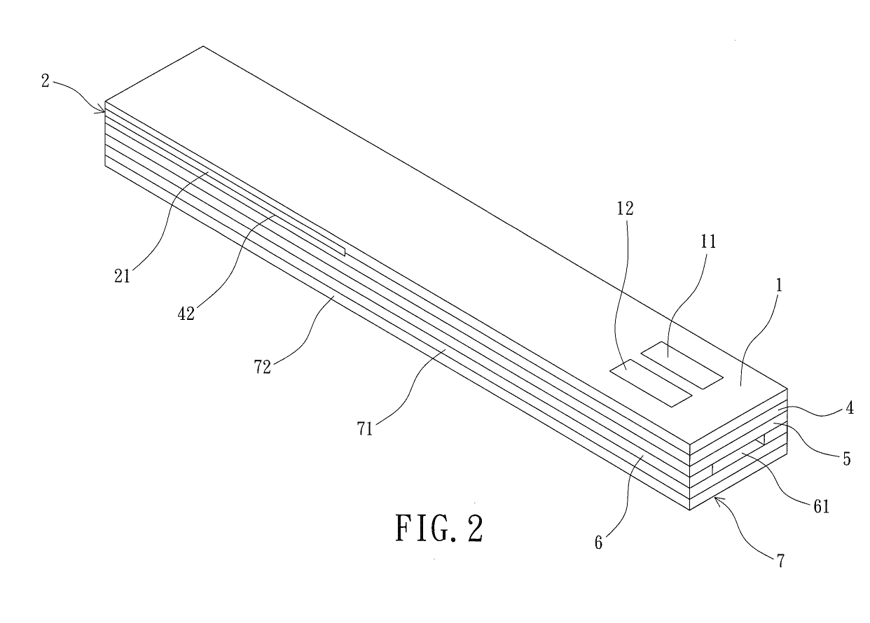

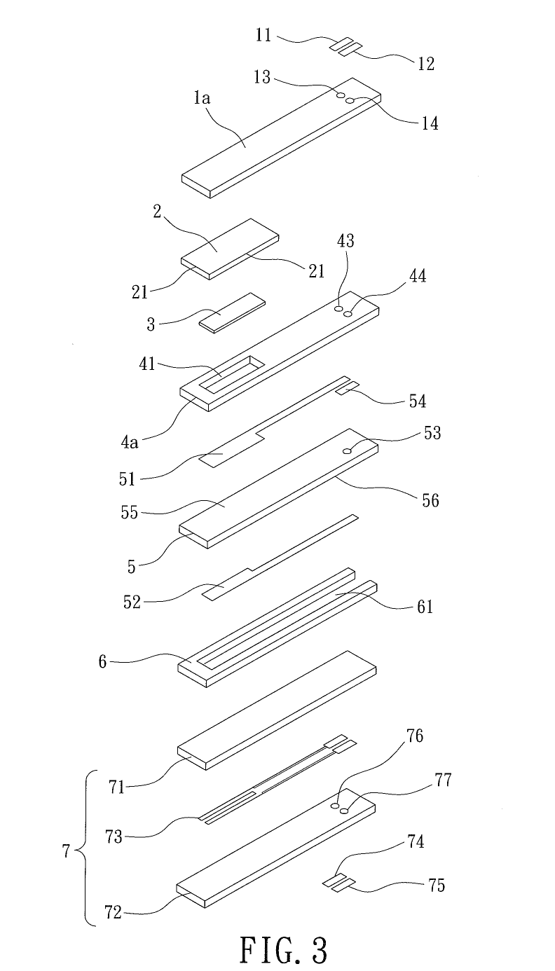

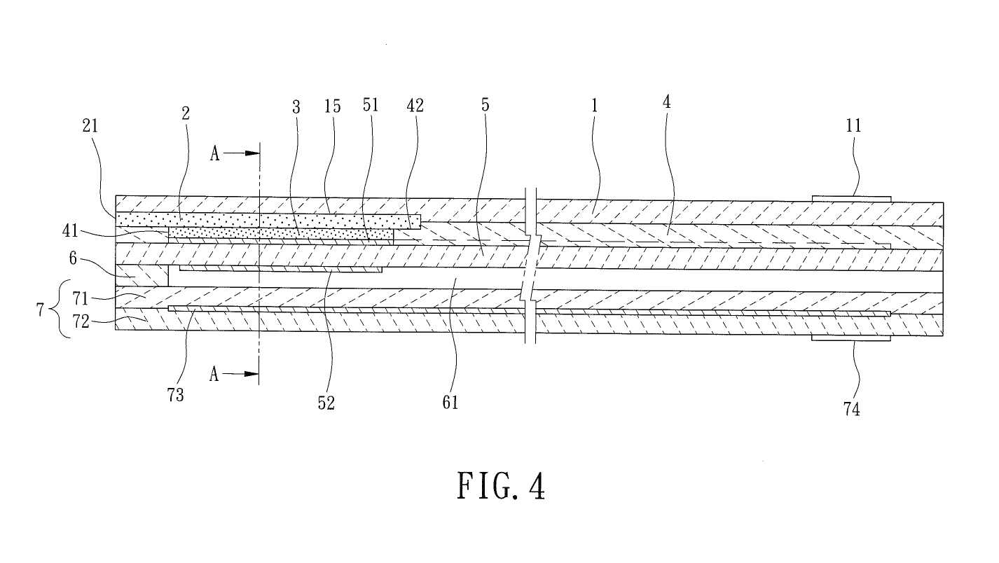

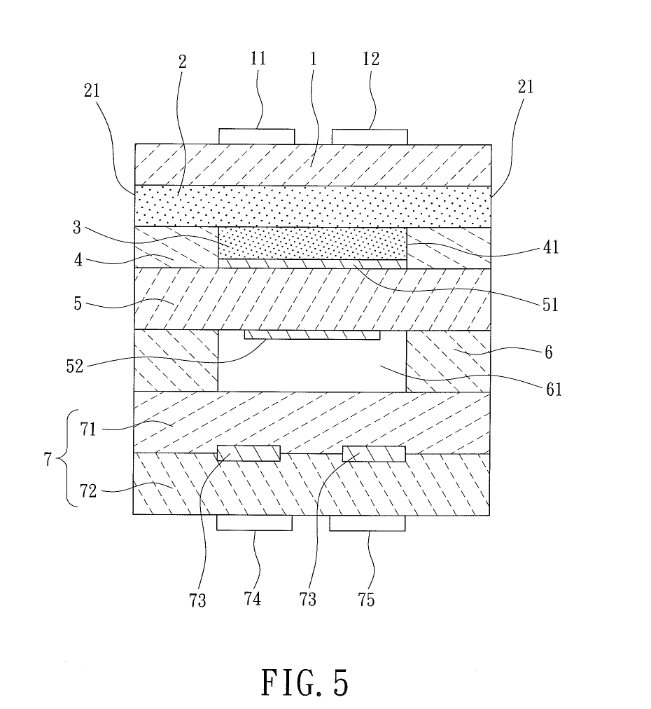

With reference to FIGS. 1-5, a gas detector according to the present invention includes both of voltage characteristics of an oxygen sensor and limit current characteristics of an air-fuel ratio sensor for use in both of injection engines and lean fuel engines. In the form shown, the gas detector includes a cover layer 1, a gas diffusion resistance layer 2, a buffer 3, a partitioning layer 4, a solid electrolyte layer 5 with first and second electrodes 51 and 52, an air passage layer 6, and a heating layer 7, which are stacked in sequence.

The cover layer 1 is not permeable to air. Conductive pads 11 and 12 are provided on the gas shield layer 1, and two through-holes 13 and 14 are formed in the cover layer 1 at locations corresponding to the conductive pads 11 and 12.

Both of the gas diffusion resistance layer 2 and the buffer 3 are made of porous ceramics. The buffer 3 is mounted in a slot 41 in the partitioning layer 4. By adjusting the thickness of the gas diffusion resistance layer 2, the cross sectional area of the diffusion path can be adjusted, and the magnitude of the limit current is in proportion to the cross sectional area of the diffusion path. The length of the diffusion path can be adjusted by adjusting the size of the slot 41, and the magnitude of the limit current is in inverse proportion to the length of the diffusion path.

The slot 41 of the partitioning layer 4 faces the first electrode 51 of the solid electrolyte layer 5. The partitioning layer 4 further includes two through-holes 43 and 44.

The solid electrolyte layer 5 is made of yttrium partial stabilized zirconium oxide and includes a first surface 55 on which the first electrode 51 is provided. The solid electrolyte layer 5 further includes a second surface 56 opposite to the first surface 55, and the second electrode 52 is provided on the second surface 56 through provision of a through-hole 53 and conductive pads 54. The area of the first and second electrodes 51 and 52 affect the oxygen pumping capacity. When a flow of oxygen flowing through the gas diffusion resistance layer 2 and the buffer 3 is smaller than the oxygen pumping capacity, a limit current is generated.

The air passage layer 6 includes an air passage 61 accessible to the second electrode 52 of the solid electrolyte layer 5 to act as an inlet for reference air when serving as an oxygen sensor or act as an outlet for pumped oxygen when serving as an air-fuel ratio for lean fuel.

The heating layer 7 includes an insulating layer 71, an insulating base layer 72, and a heating wire 73 sandwiched between the insulating layer 71 and the insulating base layer 72. The heating layer 7 further includes conductive pads 74 and 75 and through-holes 76 and 77.

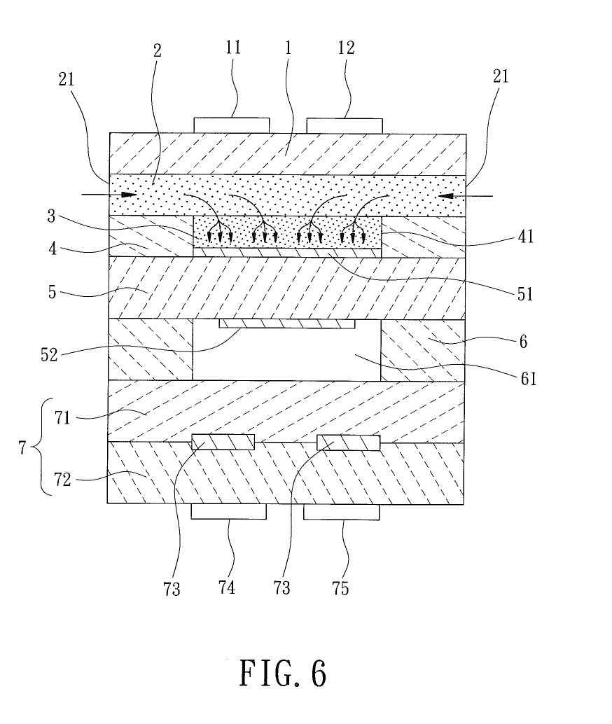

In manufacture, printed green sheets of the cover layer 1, the gas diffusion resistance layer 2, the buffer 3, the partitioning layer 4, the solid electrolyte layer 5, the air passage layer 6, and the heating layer 7 are stacked by hot pressing and then sintered at high temperature to integrally form the gas detector. Since the buffer 3 is received in the slot 41 of the partitioning layer 4 and since only outer edges 21 of the gas diffusion resistance layer 2 are exposed to the exhaust gas to be tested, the exhaust gas to be tested enter the gas detector through the outer edges 21 of the gas diffusion resistance layer 2, as indicated by the arrows in FIG. 6. Next, the exhaust gas passes through the buffer 3 and uniformly reaches the surface of the first electrode 51 of the solid electrolyte layer 5, providing a rapid response to obtain voltage characteristics of an oxygen sensor and limit current characteristics of an air-fuel ratio sensor for lean fuel. Thus, the gas detector is suitable for injection engines and lean fuel engines.

In the form shown in FIGS. 1-5, the cover layer 1 and the partitioning layer 4 are partially pressed together through hot pressing, and each of the cover layer 1 and the partitioning layer 4 is pressed to form a recessed step portion 15, 42 for sandwiching and positioning the gas diffusion resistance layer 2. Furthermore, the porosity of the buffer 3 is greater than that of the gas diffusion resistance layer 2, allowing easy passage of the exhaust gas. Further, two ends of the buffer 3 respectively contact the gas diffusion resistance layer 2 and the first electrode 51 of the solid electrolyte layer 5 to spread the exhaust gas.

With reference to FIGS. 1-6, the gas diffusion resistance layer 2 and the buffer 3 are in the form of sheet or paste made of aluminum oxide powders added with graphite or carbon powder, binder, and organic solvents. Furthermore, graphite powders and/or carbon powders of different particle size are added in different ratios to obtain porous ceramic having different permeabilities to oxygen. The thicknesses of the gas diffusion resistance layer 2 and the buffer 3 and the size of the slot 41 can be adjusted in advance to allow sufficient oxygen flow, providing a rapid response to detect the oxygen content. Furthermore, the oxygen pumping capacity can be larger than the diffusion amount under cooperation of the first and second electrodes 51 and 52 of an appropriate area, providing a limit current for detection of the air-fuel ratio for lean fuel.

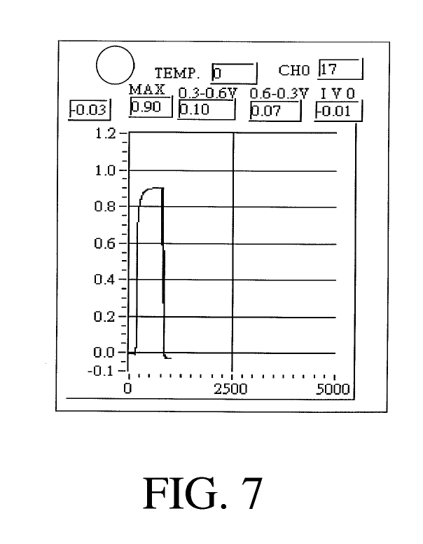

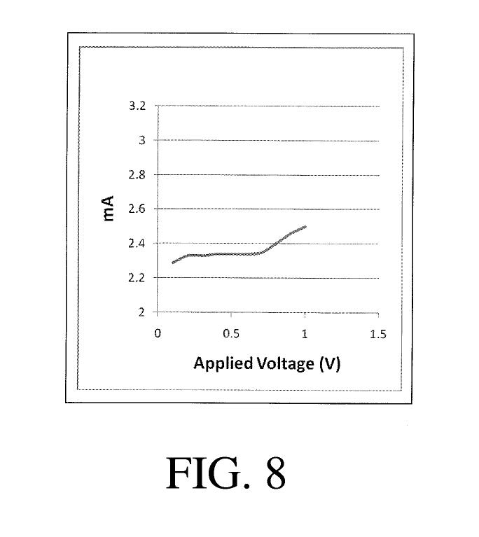

In an example, the porous ceramic for the gas diffusion resistance layer 2 is an aluminum oxide sheet having a thickness of 200 μm and containing 20% of graphite powders with particle size of 1 μm. The buffer 3 is printed using a paste composed of alumina and 30% graphite powder. The partitioning layer 4 has an overall width of 4.7 mm. The slot 41 has a width of 2.5 mm and a length of 8.5 mm. The first electrode 51 has a width of 2.5 mm and a length of 8.5 mm. The second electrode 52 has a width of 1.8 mm and a length of 7.65 mm. Sheets of the cover layer 1, the gas diffusion resistance layer 2, the buffer 3, the partitioning layer 4, the solid electrolyte layer 5, the air passage layer 6, and the heating layer 7 are pressed by hot pressing and then sintered at 1475° C. to integrally form the gas detector. After sintering, the resistance of the heating wire 73 is 2 ohms at room temperature. Tests have been conducted on the gas detector after assembly, and the test results showed that the atmosphere voltage characteristics of the gas detector meet the requirements of an ordinary oxygen sensor, as shown in FIG. 7. Furthermore, the test results on the limit current showed that the gas detector meets the requirement of an ordinary air-fuel ratio sensor for lean fuel, as shown in FIG. 8.

Although specific embodiments have been illustrated and described, numerous modifications and variations are still possible without departing from the scope of the invention. The scope of the invention is limited by the accompanying claims.

1. A gas detector comprising a cover layer, a gas diffusion resistance layer, a buffer, a partitioning layer, a solid electrolyte layer, an air passage layer, and a heating layer stacked in sequence, with the solid electrolyte layer includes a first surface and a second surface opposite to the first surface, with a first electrode provided on the first surface, with a second electrode provided on the second surface, with the partitioning layer includes a slot facing the gas diffusion resistance layer and the first electrode of the solid electrolyte layer, with the buffer received in the slot of the partitioning layer, with the air passage layer including an air passage accessible to the second electrode of the solid electrolyte layer, with the gas diffusion resistance layer including outer edges adapted to be exposed to exhaust gas to be tested, with the exhaust gas to be tested adapted to enter the gas detector via the outer edges of the gas diffusion resistance layer and reach a surface of the first electrode of the solid electrolyte layer via the buffer.

2. The gas detector as claimed in claim 1, with each of the gas diffusion resistance layer and the buffer made of porous ceramic, with the buffer having a porosity greater than a porosity of the gas diffusion resistance layer.

3. The gas detector as claimed in claim 1, with the buffer having two ends contacting the gas diffusion resistance layer and the first electrode of the solid electrolyte layer, respectively.

4. The gas detector as claimed in claim 1, with the cover layer and the partitioning layer partially pressed together, with each of the cover layer and the partitioning layer including a recessed step portion, with the gas diffusion resistance layer sandwiched and positioned by the recessed step portions of the cover layer and the partitioning layer.
